(19) United States
(12) Patent Application Publication
(10) Pub. No.: US 2004/0095077 A1
(43) Pub. Date: May 20, 2004

(54) Method of operating a gas-discharge lamp and a power supply unit

(76) Inventors: Jurgen Ludwig, Nurnberg (DE); Christian Paul, Lauf (DE)

Correspondence Address: SCULLY SCOTT MURPHY & PRESSER, PC, 400 GARDEN CITY PLAZA, GARDEN CITY, NY, 11530

(21) Appl. No.: 10/695,325

(22) Filed: Oct. 28, 2003

(30) Foreign Application Priority Data
Nov. 14, 2002 (DE) 102 52 979.5

(51) Int. Cl. H05B 37/02

(52) U.S. Cl. 315/224

(57) ABSTRACT

Proposed is a method of operating a gas discharge lamp, preferably a fluorescent lamp (10), in which the lamp is at least partly operated with a dc voltage component and voltage pulses are superimposed on that dc voltage component which can be reduced to zero. A power supply unit (11) for carrying out the method is designed in such a way that a running voltage source (13) for supplying the dc voltage and a pulse source (12) for supplying the voltage pulses are provided or can be connected.

The invention concerns a method of operating a gas-discharge lamp as set forth in the classifying portion of claim 1 and claim 2 respectively and a power supply unit for carrying out that method.

Gas-discharge lamps such as for example fluorescent lamps can be operated either with dc voltage or ac voltage. In most cases high-frequency ac voltages of frequencies of between 20 and 50 kHz are used, with frequencies of between 360 and 800 Hz in aircraft on-board systems.

If a gas-discharge lamp is not operated at full brightness but on the contrary is greatly dimmed, it becomes of very high resistance. The result of this is that operation with high-frequency ac voltage is no longer possible, when great degrees of dimming are involved since, because of the high internal resistance of the gas-discharge lamp, the current flows by way of parasitic capacitances rather than by way of the discharge path of the lamp.

In operation with dc voltage, great degrees of dimming are admittedly possible, but anode fluctuations occur, which cause unwanted flickering of the lamp.

Accordingly the object of the invention is to propose a method of the general kind set forth of operating a gas-discharge lamp and a power supply unit for carrying out that method, with which the gas-discharge lamp can be operated in flicker-free manner.

That object is attained by a method having the features of claim 1 and claim 2 respectively and a power supply unit as set forth in claim 11. Advantageous embodiments and developments of the invention are set forth in the appendant claims.

Superimposition of the dc voltage component with voltage pulses or operation solely with voltage pulses provides that no space charge zones can be formed around the anode and thus the above-mentioned anode oscillations are prevented.

In accordance with the invention it is provided that the lamp is operated in the lower brightness range with dc voltage and voltage pulses superimposed thereon or also only with voltage pulses (that is to say with a dc voltage component reduced to zero) while in the upper brightness range it can be operated selectively with dc voltage, with dc voltage and superimposed voltage pulses or however also with (preferably high-frequency) ac voltage.

The voltage pulses can be of a decaying sine form. The repetition rate of the voltage pulses is above about 100 Hz while the natural characteristic frequency of the voltage pulses is in turn above the repetition rate.

In order to reduce the brightness of the lamp, it is possible selectively or also in combination for the lamp dc voltage component to be reduced (preferably to zero), for the repetition rate of the voltage pulses to be reduced, for the voltage or energy of the pulses to be reduced or for the natural frequency of the pulses to be increased and therewith their width reduced.

In order to prevent unmixing of the lamp gases (cataphoresis) the lamp can be repeatedly subjected to pole reversal.

In a development it can further be provided that the cathode of the lamp is heated. In that situation, the heating power is only increased until the running voltage applied to the lamp does not drop any further.

A power supply unit for carrying out the foregoing method is characterised in that a running voltage source for supplying the dc voltage and a pulse source for supplying the voltage pulses are present in or can be connected to the power supply unit. In addition means for heating the lamp electrodes, for polarity reversal of the lamp and/or for measurement of the lamp running voltage can be provided or can be connected thereto.

The invention is described in greater detail hereinafter with reference to the drawing in which:

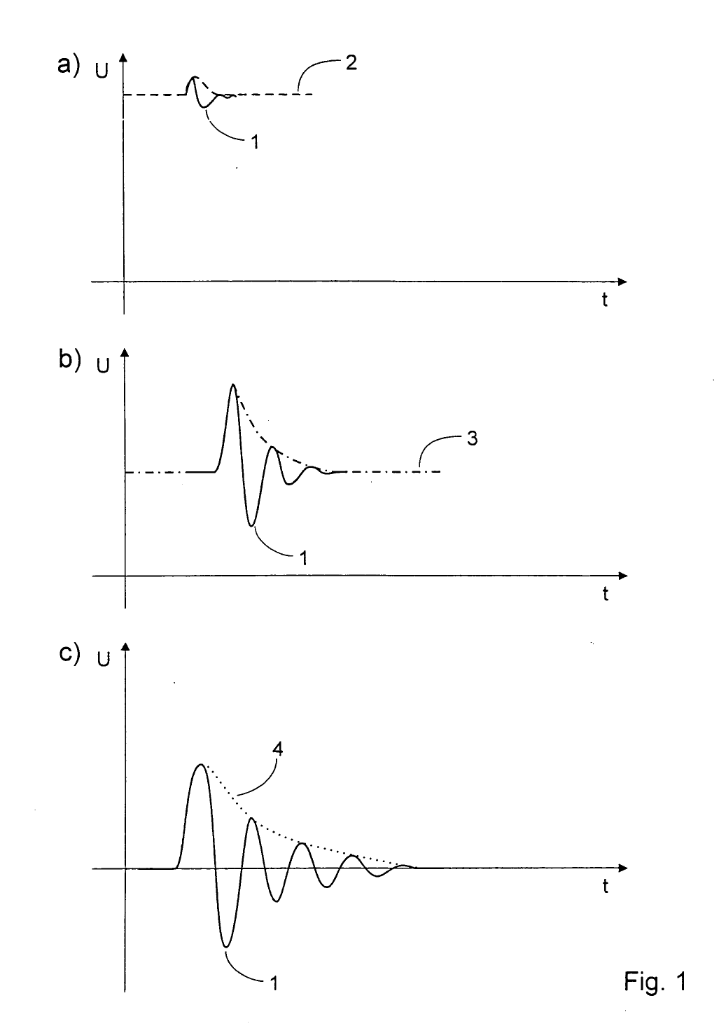

FIG. 1a shows the voltage pattern in respect of time at the lamp with a high degree of damping,

FIG. 1b shows the voltage pattern in respect of time with medium damping,

FIG. 1c shows the voltage pattern in respect of time with a low degree of damping, and

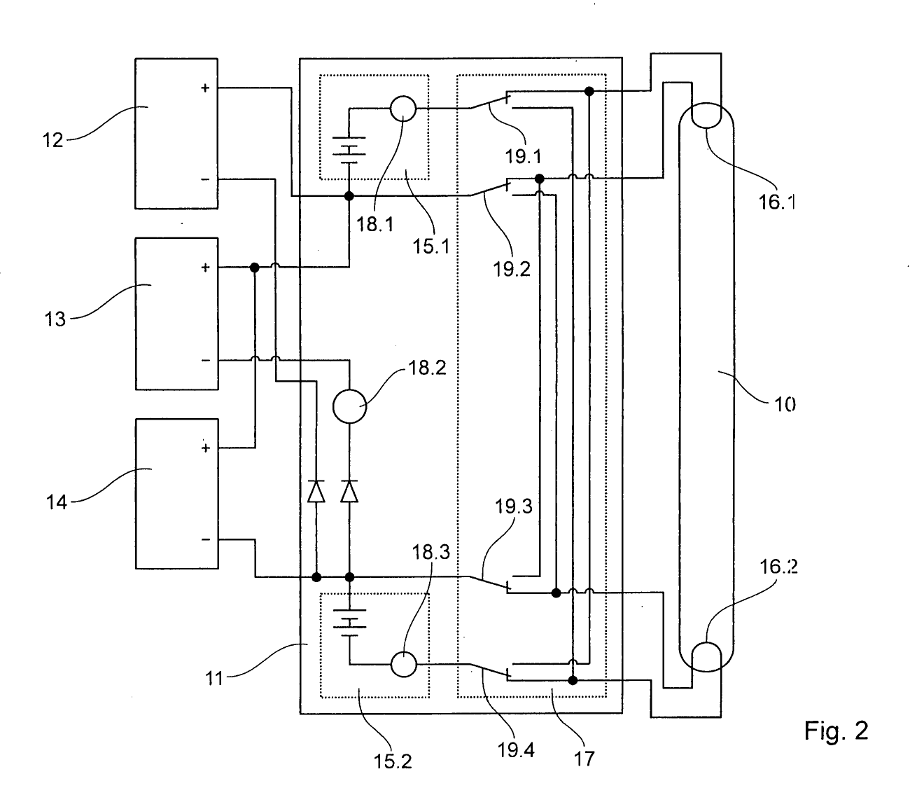

FIG. 2 shows a structural circuit diagram of the lamp operating electronics.

A fluorescent lamp 10 is operated with dc voltage and sinusoidal voltage pulses superimposed thereon. The voltage pulses (see lines 1 in FIGS. 1a-c) are in the form of a—very greatly decaying—sine.

If the fluorescent lamp 10 is operated in the upper brightness range (100% to 10% of the possible brightness or the possible lamp current), the lamp dc voltage component on which the voltage pulses are superimposed is high (see the envelope curve, broken line 2 in FIG. 1a). As the lamp is of very low resistance when operated with a high current (with a high level of brightness) the voltage, with the decay of the superimposed voltage pulses, immediately falls again to the dc voltage component (high degree of damping).

If the fluorescent lamp 10 is operated in the medium brightness range (10% to 1% of the maximum brightness or the maximum lamp current), the dc voltage component is lower (see the envelope curve, dash-dotted line 3 in FIG. 1b). With decreasing brightness, that is to say with decreasing lamp current, the internal resistance of the lamp rises so that, after decay of the voltage pulses, the voltage falls more slowly to the dc voltage component (medium damping).

If the fluorescent lamp 10 is operated in an even lower brightness range (below 1% of the maximum brightness or the maximum lamp current), the dc voltage component is further reduced until finally it has fallen entirely to zero. As, with a further fall in lamp current, the internal resistance of the lamp rises further, the drop in the voltage after decay of the voltage pulses takes place even more slowly (see the envelope curve, dotted line 4 in FIG. 1c; weak damping).

In order further to reduce the brightness of the fluorescent lamp 10, the repetition rate of the voltage pulses can be reduced, that is to say the time between two successively occurring pulses can be increased. A further reduction in the brightness of the lamp is also possible by a reduction in the voltage or the energy of the pulses. In addition, for a further reduction in brightness, it is also possible to increase the natural frequency of the pulses, that is to say, their width in respect of time can be reduced.

In order to prevent unmixing of the lamp gases (cataphoresis) by virtue of dc voltage operation of the lamp, the lamp can be repeatedly subjected to pole reversal. That pole reversal is however only necessary in the upper and medium brightness ranges (that is to say from 1000/% to about 1% o) as below that no cataphoresis occurs because of the low lamp current.

In the medium and upper brightness range, instead of operation with dc voltage, it is also possible to implement operation with an ac voltage. As from a given degree of dimming (about 10/% of the maximum possible brightness), the mode of operation changes to dc voltage superimposed with voltage pulses, in which case operation only with voltage pulses (that is to say with a dc voltage component which is reduced to zero) is also possible.

When operating the lamp with dc voltage only heating of the cathode is necessary because the anode does not have to be heated. In each brightness range, a measurement is made as to whether the heating power is sufficient. In that respect the heating power is slowly increased and at the same time the voltage applied to the fluorescent lamp 10, referred to as the lamp running voltage, is measured. As long as the heating power is not yet sufficient, the lamp running voltage decreases with increasing heating power. When a sufficient level of heating power is reached, a further increase in heating power no longer results in a change in the lamp running voltage. Thus the optimally set heating power is the value whose increase just no longer causes any drop in the lamp running voltage. In that case, the variation in the heating power takes place within admissible limits for the respective fluorescent lamp. That method admittedly requires measurement of the lamp running voltage; in most cases however that voltage is ascertained in any case. Optimum setting of the heating power affords the advantages that the service life of the electrodes and therewith the lamp becomes a maximum, the power consumption of the power supply unit and the lamp is minimal and glowing of overheated electrodes is avoided.

The foregoing method for optimum setting of the heating power is also possible independently of operation with dc voltage and voltage pulses superimposed thereon. It will be noted however that this method is important precisely with the low degrees of dimming which are possible with the dc voltage-pulse mode of operation, as in that way excessively great electrode heating and glowing of the electrode that this possibly entails can be avoided, which would be very disturbing at lower levels of lamp brightness. Optimisation of the heating power is less important at medium and high levels of brightness.

FIG. 2 shows a fluorescent lamp 10 connected to a power supply unit 11. Also connected to the power supply unit 11 are a pulse source 12, a running voltage source 13 and a running voltage measuring device 14, which (not shown) are operatively connected to an electronic control means and are controlled by way thereof. The power supply unit 11 includes two heating sources 15.1 and 15.2 for heating the electrodes 16.1 and 16.2 of the fluorescent lamp 10 and a pole reversal unit 17 and current regulating devices 18.1, 18.2 and 18.3. Switching over the switches 19.1 to 19.4 causes pole reversal of the fluorescent lamp 10 both in respect of the voltage of the running voltage source 13 and also in respect of heating by the heating sources 15.1 and 15.2. The current regulators 18.1 and 18.3 set the desired heating current through the electrodes 16.1 and 16.2 of the fluorescent lamp 10 while the current regulator 18.2 sets the desired current through the fluorescent lamp 10. Together with the current regulator 18.2 the running voltage source 13 forms a current source which supplies the current necessary for operation of the fluorescent lamp 10. That causes a voltage drop, the lamp operating voltage, at the fluorescent lamp 10.

It will be appreciated that the above-mentioned components are also actuated by way of the electronic control means (not shown).

Alternatively the heating sources 15.1 and 15.2 can also be arranged directly at the electrodes 16.1 and 16.2 of the lamp. Then only two changeover switches are required for pole reversal of the lamp.

The voltage pulse source 12 can also be disposed in series with the fluorescent lamp 10.

1. A method of operating a gas-discharge lamp, preferably a fluorescent lamp (10), wherein the lamp is operated at least in part with a dc voltage component,
characterised in that
voltage pulses are superimposed on the lamp dc voltage component.

2. A method of operating a gas-discharge lamp, preferably a fluorescent lamp (10),
characterised in that
the lamp is operated in the upper brightness range with dc voltage, with dc voltage and superimposed voltage pulses or with preferably high-frequency ac voltage while it is operated in the lower brightness range with dc voltage and superimposed voltage pulses or only with voltage pulses.

3. A method according to claim 1 or claim 2 characterised in that the voltage pulses are sinusoidal and decaying.

4. A method according to one of claims 1 to 3 characterised in that the voltage pulses have a repetition rate of at least 100 Hz and a natural frequency which is higher than the repetition rate.

5. A method according to one of the preceding claims characterised in that to reduce the brightness of the lamp the dc voltage component is reduced, preferably to zero.

6. A method according to one of the preceding claims characterised in that to reduce the brightness of the lamp the repetition rate of the pulses is reduced.

7. A method according to one of the preceding claims characterised in that to reduce the brightness of the lamp the voltage or the energy of the pulses is reduced.

8. A method according to one of the preceding claims characterised in that to reduce the brightness of the lamp the natural frequency of the pulses is increased.

9. A method according to one of the preceding claims characterised in that the lamp is repeatedly subjected to pole reversal.

10. A method according to one of the preceding claims characterised in that the cathode of the lamp is heated, wherein the heating power is only selected to be so great that an increase in the heating power does not cause any further reduction in the running voltage of the lamp.

11. A power supply unit (11) for carrying out the method according to one of the preceding claims characterised in that a running voltage source (13) for supplying the dc voltage and a pulse source (12) for supplying the voltage pulses are provided or can be connected.

12. A power supply unit according to claim 11 characterised in that means (15.1, 15.2) for heating the lamp electrodes (16.1, 16.2), means (17) for pole reversal of the lamp and/or means (14) for measuring the lamp running voltage are provided or can be connected.
